(19) United States
(12) Patent Application Publication
(10) Pub. No.: US 2015/0186932 A1
(43) Pub. Date: Jul. 2, 2015

(54) SYSTEMS AND METHODS FOR A UNIFIED AUDIENCE TARGETING SOLUTION

(71) Applicant: Yahoo! Inc., Sunnyvale, CA (US)

(72) Inventors: Jian XU, Beijing (CN); Yu Zou, Beijing (CN)

(73) Assignee: Yahoo! Inc., Sunnyvale, CA (US)

(21) Appl. No.: 14/144,130

(22) Filed: Dec. 30, 2013

Related U.S. Application Data
(63) Continuation of application No. PCT/CN2012/090731, filed on Dec. 27, 2013.

(51) Int. Cl. G06Q 30/02

(52) U.S. Cl. CPC G06Q 30/0251; G06Q 30/0269

(57) ABSTRACT

Systems and methods for providing a unified targeting solution are disclosed. The system obtains user data for each user in a user group from a database stored in the non-transitory storage medium. The database is organized on a user by user basis and includes signals from a plurality of sources. The system receives an input from an advertiser including a marketing intention. The system includes features extracted from the user data and the input. The system obtains a score for each user based on the extracted features. The system selects users from the user group based on the obtained scores.

### CROSS-REFERENCE TO RELATED APPLICATIONS

This application is a continuation of International Application No. PCT/CN2013/090731, filed on Dec. 27, 2013, which is hereby incorporated herein by reference in its entirety.

### BACKGROUND

In marketing and advertising, a target audience is a specific group of people within the target market at which a product or the marketing message of a product is aimed at. For example, if a company sells new diet programs for men with a specific disease, the target audience may include the spouse who takes care of the nutrition plan of her husband and child.

Generally, a target audience can be selected based on certain characteristics such as age, gender, marital status, etc. For example, teenagers may be part of the target audience for video games. Other groups, although not the main focus, may also be interested, such as the parents of the teenagers. Selecting the appropriate target audience for a particular product or service is one of the most important activities in marketing management.

Selecting the target audience may be implemented in online advertising computer systems. For example, Yahoo! has been one of the providers for such online advertising computer systems. Audience targeting is a method to select the appropriate target audience from a user database such that the selected users are receptive to the marketing messages from an advertiser.

Conventional online advertising computer systems require the advertiser to specify each rule individually for each characteristic of the targeting audience. Because there are so many user characteristics, the advertiser may need to go through a very large number of signals about each characteristic to identify the desired audience. Further, conventional online advertising computer systems do not allow the advertiser to treat each user using all available data from different data sources.

Thus, the conventional online advertising computer system fails to provide an effective audience targeting solution for the advertisers to identify the desired audience. It would be desirable to develop new systems and methods for selecting desired target audience.

### SUMMARY

In the disclosed method, the characteristics from different data sources are stored and updated in a unified database on a user by user basis. Thus, the computer system may treat audience targeting as a user-retrieval problem using all the characteristics. The advertiser's marketing intent may be treated as a query and the user may be treated as a document. Users are retrieved and ranked against the query and the desired top ranked users are selected as the target audience.

One embodiment discloses a computer system for selecting a target audience. The computer system includes a processor and a non-transitory storage medium accessible to the hardware processor. The system includes a database including user data for each user in a user group. The database is organized on a user by user basis and includes signals from a plurality of sources. The system includes an input set by an advertiser including a marketing intention. The system includes features extracted from the user data and the input. The system includes a score for each user based on the extracted features. The system includes a module that selects users from the user group based on the obtained scores.

Another embodiment discloses a method or program for selecting target audience implemented in a computer system. In the computer implemented method, the system stores and updates user data in a database on a user by user basis, where the user data include signals from a plurality of sources. The system obtains user data for each user in a user group from the database. The system receives an input from an advertiser including a marketing intention. The system extracts features respectively from the user data and the input. The system obtains a score for each user based on the extracted features. The system selects users from the user group based on the obtained scores and targets the selected users with an advertisement corresponding to the marketing intention.

### BRIEF DESCRIPTION OF THE DRAWINGS

FIG. 1 is an example computer system according to one embodiment of the disclosure;

FIG. 2A illustrates an example device for selecting a target audience;

FIG. 2B illustrates an example system for selecting a target audience;

FIG. 3 is an example block diagram illustrating one embodiment of the disclosure; and

FIG. 4 is an example block diagram illustrating one embodiment of the disclosure.

### DETAILED DESCRIPTION OF THE DRAWINGS

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The term “social network” refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like.

A social network may include individuals with similar experiences, opinions, education levels or backgrounds. Subgroups may exist or be created according to user profiles of individuals, for example, in which a subgroup member may belong to multiple subgroups. An individual may also have multiple “1:few” associations within a social network, such as for family, college classmates, or co-workers.

An individual's social network may refer to a set of direct personal relationships or a set of indirect personal relationships. A direct personal relationship refers to a relationship for an individual in which communications may be individual to individual, such as with family members, friends, colleagues, co-workers, or the like. An indirect personal relationship refers to a relationship that may be available to an individual with another individual although no form of individual to individual communication may have taken place, such as a friend of a friend, or the like. Different privileges or permissions may be associated with relationships in a social network. A social network also may generate relationships or connections with entities other than a person, such as companies, brands, or so-called ‘virtual persons.’ An individual's social network may be represented in a variety of forms, such as visually, electronically or functionally. For example, a “social graph” or “socio-gram” may represent an entity in a social network as a node and a relationship as an edge or a link.

For web portals like Yahoo!, advertisements may be displayed on web pages resulting from a user defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users. One approach to presenting targeted advertisements includes employing demographic characteristics (e.g., age, income, sex, occupation, etc.) for predicting user behavior, such as by group. Advertisements may be presented to users in a targeted audience based at least in part upon predicted user behavior(s).

Another approach includes profile type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users.

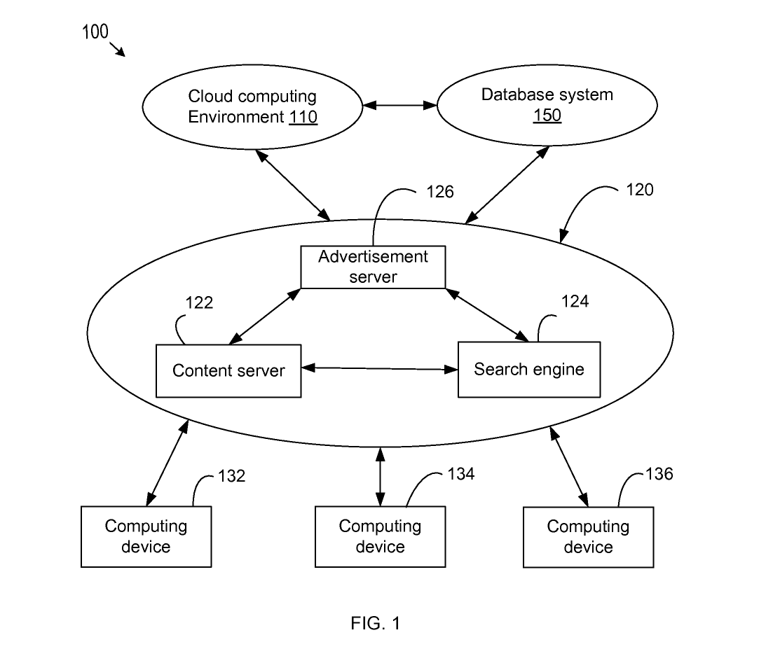

FIG. 1 is a block diagram of one embodiment of an environment 100 in which a system for a unified audience targeting solution may operate. However, it should be appreciated that the systems and methods described below are not limited to use with the particular exemplary environment 100 shown in FIG. 1 but may be extended to a wide variety of implementations.

The environment 100 may include a cloud computing environment 110 and a connected server system 120 including a content server 122, a search engine 124, and an advertisement server 126. The server system 120 may include additional servers for additional computing or service purposes. For example, the server system 120 may include servers for social networks, online shopping sites, and any other online services.

The content server 122 may be a computer, a server, or any other computing device known in the art, or the content server 122 may be a computer program, instructions, and/or software code stored on a computer-readable storage medium that runs on a processor of a single server, a plurality of servers, or any other type of computing device known in the art. The content server 122 delivers content, such as a web page, using the Hypertext Transfer Protocol and/or other protocols. The content server 122 may also be a virtual machine running a program that delivers content.

The search engine 124 may be a computer system, one or more servers, or any other computing device known in the art, or the search engine 124 may be a computer program, instructions, and/or software code stored on a computer-readable storage medium that runs on a processor of a single server, a plurality of servers, or any other type of computing device known in the art. The search engine 124 is designed to help users find information located on the Internet or an intranet.

The advertisement server 126 may be a computer system, one or more servers, or any other computing device known in the art, or the advertisement server 126 may be a computer program, instructions and/or software code stored on a computer-readable storage medium that runs on a processor of a single server, a plurality of servers, or any other type of computing device known in the art. The advertisement server 126 is designed to provide digital ads to a web user based on display conditions requested by the advertiser.

The cloud computing environment 110 and the connected server system 120 have access to a database system 150. The database system 150 may include one or more databases. At least one of the databases in the database system may be a user database that stores information related to a plurality of users. The user database may be organized on a user-by-user basis such that each user has a unique record file. The record file may include all information related to a specific user from all data sources. For example, the record file may include personal information of the user, search histories of the user from the search engine 124, web browsing histories of the user from the content server 122, or any other information the user agreed to share with a service provider that is affiliated with the computer system 120.

The environment 100 may further include a plurality of computing devices 132, 134, and 136. The computing devices may be a computer, a smart phone, a personal digital aid, a digital reader, a Global Positioning System (GPS) receiver, or any other device that may be used to access the Internet.

Generally, an advertiser or any other user can use a computing device such as computing devices 132, 134, 136 to access information on the server system 120. The advertiser may want to identify a target audience for his/her product or services. In some cases, the advertiser may already have a very specific idea about the target audience. Existing solutions may require the advertisers to create a set of rules to define the desired segment of users they want to target. The rules are connected with logical connectors such as “AND/OR” to determine the qualifications of a user. Advertisers/account managers need to contend with millions of different targeting signals to identify the optimal set of signals. The signals may include all kinds of information related to each user from a plurality of sources accessible to the server system 120. The signals may relate to social network data, search history data, browsing history data, shopping activity data, demographic data, or any data users agreed to share with the server system 120. The situation becomes even tougher when determining which signals play a positive role in the segment and which are not.

Most of the time, however, the advertiser may only have general information about his market intention and it would be difficult for the advertiser to create the above rules to determine the qualifications of the desired users. For example, the advertiser may only have information about the product, the related service, some statistics about the current customers, and an image or a video related to his product or service.

In the general solutions provided by conventional advertising systems, the selected users are not ranked based on all the available information. Further, the designed rules may be connected with logical OR expressions. For example, the designed rules may include “Liked 10 social ‘Likes’ that match the advertiser's first set of specifications” OR “Liked only 1 social ‘Like’ that matches the advertiser's second specification.” In this case, one user may be selected by meeting a handful of rules related to the first set of specifications while the other users may be selected merely because of one rule related to the second specification.

The users are selected based on piecemeal information such as an incidental activity happened in the past. Each selected user meets at least one rule while each non-selected user meets no rule. Thus, the number of selected users (i.e. segment size) cannot be changed flexibly without changing the rules. Because users are not ranked based on all the available information as a whole, it is difficult for the conventional advertising systems to tune segment size to expand or reduce the target audience. The advertiser will have to change the rules (e.g. add or delete some rules on more signals), which may be tricky and risky. Sometimes some users are marginal to the advertisers. For example, advertisers would like to target users who have traveled by plane more than four times within the last month. Those who traveled three times are usually marginal to the advertisers especially when the number of selected users is less than desired. It would be difficult for the advertiser to decide which marginal users to pick using the piecemeal information.

By contrast, embodiments of the disclosed system and method solve the above problems by scoring based on extracted features and selecting the targeting audience based on the score. The disclosed system receives an input from the advertiser, where the input includes the market intention. The system then automatically analyzes the input and extracts features from the input and uses the extracted features to automatically identify the desired users. Thus, the advertiser does not have to go through all the different requirements about each keywords or signals from different data sources.

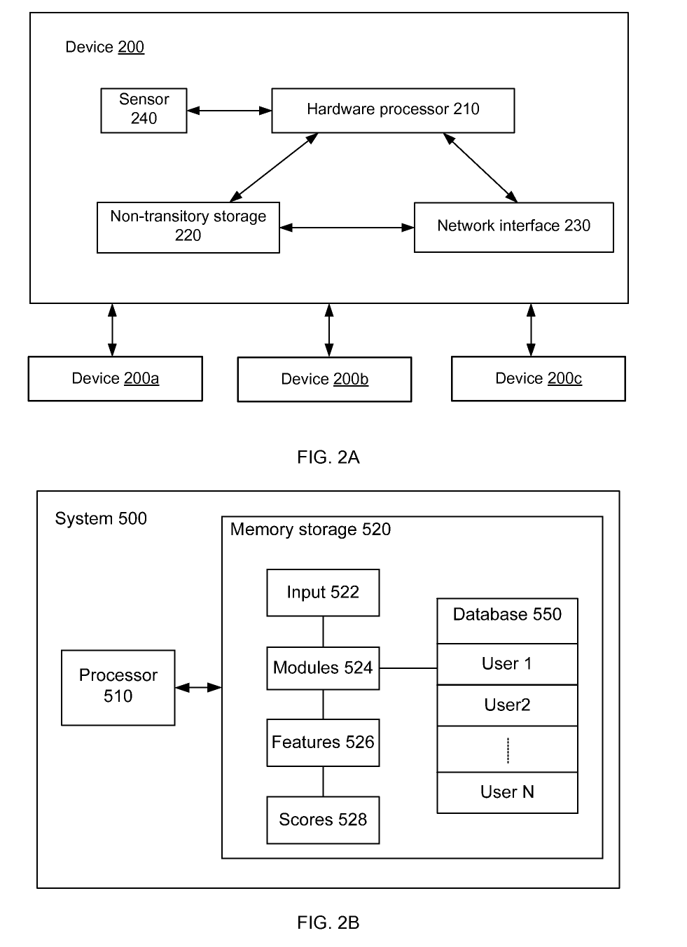

FIG. 2A illustrates an example device 200 for selecting a target audience. The device may 200 may be a computer, a smartphone, a server, a terminal device, or any other computing device including a hardware processor 210, a non-transitory storage medium 220, and a network interface 230. The hardware processor 210 accesses the programs and data stored in the non-transitory storage medium 220. The device 200 may further include at least one sensor 240. The device may communicate with other devices 200a, 200b, and 200c via the network interface 230.

FIG. 2B illustrates an example system 500 for selecting a target audience. The system 500 may include one or more devices illustrated in FIG. 2A. For example, the system 500 includes a processor 510 and a storage medium 520 accessible to the processor 510. The storage medium 520 may include a non-transitory storage medium and a transitory storage medium. The storage medium 520 may include a plurality of data modules and program modules. The data modules may include input 522 from the advertiser, features 526 generated by the modules, and scores 528. The program modules 524 may be implemented by the processor 510.

The storage medium 520 may also include a database 550 including user data for each user in a user group. The database 550 may include more than one user groups. The database 550 is organized on a user by user basis and includes signals from a plurality of websites.

The input 522 may include a marketing intention from the advertiser. The input 522 may further include a preset number set by the advertiser. Based on the user data and input 522, one or more modules 524 may extract features from the input and the user data. The extracted features 524 may be store in the storage medium 520. The extracted features 524 may include both input features related to the input 522 and user features related to the user data from each user.

The one or more modules 524 may then obtain a score for each user based on the extracted features. The obtained scores 528 may be stored in the storage medium 520 for further analysis. In one embodiment, the one or more modules select users from the user group based on the scores 528 of each user in the user group. In other words, each user in the database 550 is stored like a document, which is processed as a whole and ranked based on the similarities between the input features and the user features. The processor 510 may target the selected users with an advertisement corresponding to the marketing intention.

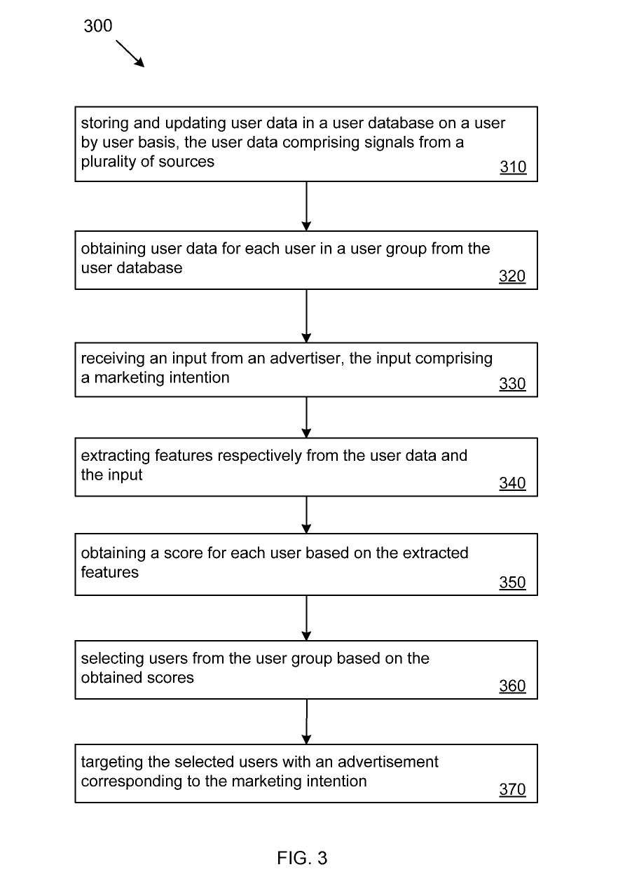

FIG. 3 is an example block diagram 300 illustrating one embodiment of a method for selecting a target audience. The block diagram 300 may be implemented by a computer system 500 including at least one computing device 200 disclosed in FIG. 2A. The computer implemented method according to the example block diagram 300 includes the following steps. Other steps may be added or substituted.

In step 310, the computer stores and updates user data in a database on a user by user basis, where the user data includes data signals from a plurality of sources. Each user may have a unique record file in the database. Each record file stores data signals that include semantic signals and non-semantic signals. For example, the semantic signals may include at least one of the following: webpage content, search history, ad click history, data in the social network, texts in the blogs, email keywords, other user generated information, and other information the user agreed to share with the online service provider affiliated with the computer system. The non-semantic signals may include at least one of the following: geographical location of the user, user age, user gender, the device being used by the user, and life stage of the user.

In step 320, the computer system obtains user data for each user in a user group from the user database. The user database may be stored in a non-transitory storage medium. The advertiser may specify a few rules to pre-select a user group from the user database. For example, the advertiser may specify a geographical region, an age range, or other user information he already has in mind. The computer system thus can start with a relatively smaller user group.

In step 330, the computer system receives an input from an advertiser including a marketing intention. The market intention may be a query that describes the advertiser's intent or preference of the targeted users. For example, the query may include at least one of the following: the ad campaign to be delivered to the targeted users, the advertiser's industry, the competing product, the competing company, and some descriptions in natural language. The input from the advertiser may also include a preset number that defines the size of the target audience.

In step 340, the computer system extracts features respectively from the user data and the input. Depending on the type of input from the advertiser, the computer system may use pattern recognition, image segmentation, natural language processing (NLP), or any other technology to extract features from the input. The computer system may also extract features in the obtained user data for each user.

The extracted features may include at least one of the following: an advertisement keyword, an ad category, and a topic. For example, the computer system may identify an advertisement keyword and ad category by voice recognition of an audio input from the advertiser. Similarly, the computer system may extract topics from a natural language input by using NLP. The computer system may find keywords and topics in the user data such as emails, social network information, and so on by similar technology or directly by user preference. For instance, the user may choose to receive certain market information from a website once a month and the computer system may analyze the user choice and identify that the user may be interested in products from the website.

In an example embodiment, the extracted user features from the user data may include features from user's content reading, search, mails, social media “Like”s, and other user-generated content. The extracted user features may further include non-semantic features such as: demographic information (age, gender, etc.), geographical information, Techno. On the advertiser side, the extracted ad features may include features from ad description, advertiser's industry, product description, etc. The extracted ad features may also include ad position, historical performance of advertiser's campaigns, etc.

In step 350, the computer system obtains a score for each user based on the extracted features. The score may be obtained by measuring the semantic relevance between query and user, or by calculating the click probability of a user on a given ad category. The score may also consider the non-semantic information in the user data and the input. For example, an initial score may be obtained based on the semantic relevance and the click probability and the initial score may be weighted by a weight related to the geographical distance between the user and the advertiser facilities.

Following are three examples to obtain the score. A person having ordinary skill in the art would know that the three examples may be combined in some cases and may be extended to other implementations as well.

Example 1. Query=Ad, Score=Relevance(Ad, User)

Relevance(Ad,User)=Σ_{Fε{BOW,Entity,CAT,etc.}}α_{F}Σ_{fεF}α_{f}u_{f}

where α_{f} and u_{f} are the values of the common feature f between Ad and User,

u_{f}=Σ_{sourceε{Content,Search,Mail,Social,UGC, . . . }}β_{source u}_{_{f}}_{^{source}},

α_{F}: weight different feature types, and

β_{source}: weight of different feature sources.

Example 2. Query=Ad, Score=P(click|Ad, User)

P(click|Ad,User)=γ₀+Σ_{Fε{BOW,Entity,CAT,etc.}}Σ_{fεF}γ_{f}α_{f}u_{f}

where α_{f} and u_{f} are the values of the common feature f between Ad and User,

u_{f}=Σ_{sourceε{Content,Search,Mail,Social,UGC, . . . }}β_{source u}_{_{f}}_{^{source}},

γ_{f} weight of interactive feature α_{f}u_{f} in the click model, to be learned with click feedback data,
β_{source}: weight of different feature sources.

Example 3. Query=category,

Score=P(click|category, User)

P(click|category,User)=θ₀+Σ_{catεCAT}θ_{cat}u_{cat}

θ_{cat}=Σ_{sourceε{Content,Search,Mill,Social,UGC, . . . }}β_{source}_{_{cat}}_{^{source}},

θ_{cat}: weight of feature u_{cat} in the click model, and
β_{source}: weight of different feature sources.

Here, the query may include anything that describes the advertiser's marketing intent. For example, the query may include an ad, the advertiser's product line, a Bazooka category, etc. The score measures how much a user matches the advertiser's intent using all the available data in the user data. The score may include a relevance score and a performance score. The relevance score quantifies how relevant a user is to the query. The performance score quantifies the probability of a user to react. For example, the performance score may include at least one of: a click probability, a convert probability, an estimated dwell time, and other performance values.

A generalized score model may be described by the following mathematic model.

$$score ( Query , User ) = {φ}_{U} ( {\{ {\sum }_{s ∈ Src}^{ } {θ}_{f}^{s} {u}_{f}^{s} \}}_{f ∈ {F}_{U}} ) + {φ}_{Q} ( {\{ {q}_{f} \}}_{f ∈ {F}_{Q}} ) + {φ}_{C} ( {\{ ϕ ( {\sum }_{s ∈ Src}^{ } {θ}_{f}^{s} {u}_{f}^{s} , {q}_{f} ) \}}_{f ∈ {F}_{U} ⋂ {F}_{Q}} )$$

Here, θ is the parameter family used to combine feature values from different data sources. Data sources may include content, search, mail, social, and UGC. φ_{U} corresponds to user side features, φ_{Q} corresponds to query side features, and φ_{Q} corresponds to cross features on both user and query sides. The three sets of features may be weighted by three sets of parameters. For example, the p_{φU}, p_{φQ}, p_{φC} are parameter families used in modeling score(query, user), corresponding to user-side features, query-side features and cross features respectively. These parameters may be preset or leaned using one or more machine leaning models.

Different queries may invoke different parameter values. For example, behavioral targeting (BT) may invoke parameter family p_{φU}, and different BT categories may invoke different parameter values within p_{φU}.

In step 360, the computer system selects users from the user group based on the obtained scores. The advertiser may identify a preset number K in the input and the computer system can then selects the top K ranked users based on the obtained score for each user in the use group. In other words, K is the desired user segment size. The advertiser may later increase this preset number if the performance of the targeting audience generates the desired amount of revenue.

In step 370, the computer system targeting the selected users with an advertisement corresponding to the marketing intention. For example, the computer system may place ads in the social networks of the selected users. The computer system may show banner ads when the selected users access one webpage affiliated with the computer system.

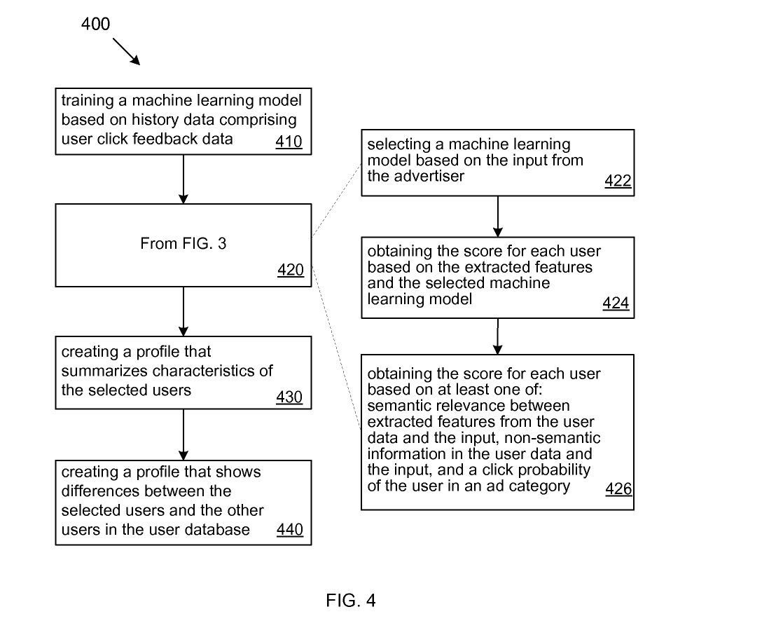

FIG. 4 is an example block diagram illustrating one embodiment of a method for selecting a target audience.

In step 410, the computer system trains a machine learning model based on history data comprising user click feedback data. The machine learning model may be trained to determine at least one of the above parameters: p_{φU}, p_{φQ}, p_{φC}.

In step 420, the computer system may implement the steps in FIG. 3. The step 420 may further include steps 422, 424, and 426. In step 422, the computer system selects a machine learning model based on the input from the advertiser. In step 424, the computer system obtains the score for each user based on the extracted features and the selected machine learning model. In step 426, the computer system obtaining the score for each user comprising obtaining the score for each user based on at least one of the following: semantic relevance between extracted features from the user data and the input, non-semantic information in the user data and the input, and a click probability of the user in an ad category.

In step 430, the computer system creates a profile that summarizes characteristics of the selected users. The profile may help the advertiser to understand the target audience and fine tune the target audience in the future.

In step 440, the computer system may further analyze the profile and show the major differences. This analysis may determine which variable(s) discriminate between the selected user and the unselected users in the user group. The analysis is carried out automatically and top N discriminative variables are identified, where N may be preset by the advertiser. Statistics of the selected user and the other users on these N variables are output for a comparison. The output may include a table, a drawing, and a chart.

The disclosed computer implemented method may be stored in computer-readable storage medium. The computer-readable storage medium is accessible to at least one hardware processor. The processor is configured to implement the stored instructions to select a target audience based on extracted features from the user data and the advertiser input.

From the foregoing, it can be seen that the present embodiments provide a unified audience targeting solution to precisely identify the desired audience for a marketing intent. The computer system obtains user data for each user in a user group from a database stored in the non-transitory storage medium. The user database is organized as a user by user basis and includes signals from a plurality of sources. The system receives an input from an advertiser including a marketing intention. The system extracts features respectively from the user data and the input. The system obtains a score for each user based on the extracted features. The system selects users from the user group based on the obtained scores and targets the selected users with an advertisement corresponding to the marketing intention.

The disclosed system has the following advantages. The advertisers do not need to struggle within millions of heterogeneous signals to identify the desired audience. The advertisers' intents are converted into a query and desired users are retrieved automatically. The optional segment profiling makes sure the targeting process transparent to the advertisers. The method may be fully customized because each advertiser can have its unique query. Advertisers still have complete control in the user segment definition by specifying rules on the user profiles. The scoring models are performance optimized to score users and the advertisers may tune the performance and/or reach by tuning the segment size.

It is therefore intended that the foregoing detailed description be regarded as illustrative rather than limiting, and that it be understood that it is the following claims, including all equivalents, that are intended to define the spirit and scope of this invention.

What is claimed is:

1. A system comprising a processor and a non-transitory storage medium accessible to the processor, the system comprising:
a database comprising user data for each user in a user group, the database organized on a user by user basis and comprising signals from a plurality of websites;
an input set by an advertiser, the input comprising a marketing intention;
a set of features extracted from the user data and the input;
a score for each user based on the extracted features; and
a module that selects users from the user group based on the scores.

2. The system of claim 1, wherein the input comprises a preset number set by the advertiser.

3. The system of claim 2, wherein the module is further configured to select top scored users based on the extracted features and the preset number.

4. The system of claim 1, wherein the set of features extracted from the user data and the input comprises at least one of the following:
an advertisement keyword,
an ad category, and
a topic.

5. The system of claim 1, wherein the processor is configured to obtain the score based on at least one of the following:
semantic relevance between extracted features from the user data and the input,
non-semantic information in the user data and the input, and
a click probability of the user in an ad category.

6. The system of claim 1, wherein the processor is further configured to obtain the score based on a trained model.

7. The system of claim 1, wherein the processor is further configured to create a profile that summarizes characteristics of the selected users and target the selected users with an advertisement corresponding to the marketing intention.

8. The system of claim 1, wherein the processor is configured to create a profile that shows differences between the selected users and the other users in the user group.

9. A method, comprising:
storing and updating user data in a database on a user by user basis, the user data comprising signals from a plurality of sources;
obtaining, by one or more devices having a processor, user data for each user in a user group from the database;
receiving, by the one or more devices, an input from an advertiser, the input comprising a marketing intention;
extracting, by the one or more devices, features respectively from the user data and the input;
obtaining, by the one or more devices, a score for each user based on the extracted features;
selecting, by the one or more devices, users from the user group based on the obtained scores; and
targeting the selected users with an advertisement corresponding to the marketing intention.

10. The method of claim 9, further comprising:
receiving, by the one or more devices, an input from an advertiser, the input comprising a preset number related to an objective of the advertiser.

11. The method of claim 10, further comprising:
selecting a machine learning model based on the input from the advertiser; and
obtaining the score for each user based on the extracted features and the selected machine learning model.

12. The method of claim 9, wherein extracting features respectively from the user data and the input comprising:
extracting at least one of the following features respectively from the user data and the input:
an advertisement keyword,
an ad category, and
a topic.

13. The method of claim 9, wherein obtaining the score for each user comprising obtaining the score for each user based on at least one of the following:
semantic relevance between extracted features from the user data and the input,
non-semantic information in the user data and the input, and
a click probability of the user in an ad category.

14. The method of claim 9, further comprising: creating a profile that summarizes characteristics of the selected users.

15. The method of claim 9, further comprising: creating a profile that shows differences between the selected users and the other users in the user group.

16. The method of claim 9, further comprising: training a machine learning model based on history data comprising user click feedback data.

17. A non-transitory storage medium configured to store a set of instructions, the set of instructions to direct a computer system to perform acts of:
storing and updating user data in a database on a user by user basis, the user data comprising signals from a plurality of sources;
obtaining user data for each user in a user group from the database;
receiving an input from an advertiser, the input comprising a marketing intention;
extracting features respectively from the user data and the input;
obtaining a score for each user based on the extracted features; and
selecting users from the user group based on the obtained scores; and
targeting the selected users with an advertisement corresponding to the marketing intention.

18. The non-transitory storage medium of claim 17, wherein the set of instructions to direct the computer system to
select a machine learning model based on the input from the advertiser; and
obtain the score for each user based on the extracted features and the selected machine learning model.

19. The non-transitory storage medium of claim 17, wherein extracting features respectively from the user data and the input comprising:
extracting at least one of the following features respectively from the user data and the input:
an advertisement keyword,
an ad category, and
a topic.

20. The non-transitory storage medium of claim 17, wherein obtaining the score for each user comprising obtaining the score for each user based on at least one of the following:
semantic relevance between extracted features from the user data and the input,
non-semantic information in the user data and the input, and
a click probability of the user in an ad category.
